(19) United States
(12) Patent Application Publication
(10) Pub. No.: US 2005/0239320 A1
(43) Pub. Date: Oct. 27, 2005

(54) Floor mat connection system

(76) Inventor: Gary Folkema, Ingersoll (CA)

Correspondence Address: MARK A KOCH, 866 MAIN STREET EAST, HAMILTON, ON, L8M1L9, CA

(21) Appl. No.: 11/094,166

(22) Filed: Mar. 31, 2005

Related U.S. Application Data
(60) Provisional application No. 60/558,579, filed on Apr. 2, 2004.

(51) Int. Cl. H01R 4/24

(52) U.S. Cl. 439/404

(57) ABSTRACT

The present invention is a floor mat connection device for connecting mat ends together. The device includes a male connector; a female connector and structure for interlocking the male and the female connector such that the mat ends are sandwiched between portions of the male and female connector. The interlocking structure including a male vertical portion connected to the male connector and a co-operating female vertical portion connected to the female connector, the vertical portions for operably interlocking the male and female connectors. The male vertical portion including a male plug in leg and the female vertical portion including a female receptor such that urging the male plug in leg into the female receptor locks the male connector to the female connector. The male vertical portion may include a serrated leg, and the female vertical portion including a serrated receptor for receiving the serrated leg, such that urging the serrated leg into the serrated receptor interlocks the male and female connectors.

The present application claims priority from previously filed U.S. provisional application 60/558579 titled FLOOR MAT CONNECTION SYSTEM by GARY FOLKEMA which was filed on Apr. 4, 2004.

### FIELD OF THE INVENTION

The present invention relates to interconnecting floor mat systems, in particularly relates to a floor mat connection system for use in cattle and equine applications.

### BACKGROUND OF THE INVENTION

Presently rubber matting is often used in both the dairy, cattle and equine industry for providing for a softer floor for animals to prevent aching feet, numb legs, and lameness of animals. Cows, for example often spend up to 10 hours a day standing and walking on concrete floors. Many farmers feel that a major reason for culling is lameness associated with walking on hard floors. Experts in the field have indicated that flooring for cattle should provide comfort and confident footing for cows and unfortunately, concrete is not the most comfortable flooring for animals. In this regard, some dairy operations, for example have installed rubber flooring and matting of various kinds in order to provide greater comfort for the animals. Farmers are looking for ways to improve flooring conditions which is closer to pasture like conditions, since there is some evidence to suggest that cows give more milk when their walking conditions and standing conditions have been adjusted to be as close as possible to pasture like conditions.

A number of the present art rubber matting and/or flooring systems include interlocking rubber mats and flooring which are simply laid on the existing concrete floors and interlock together in a similar fashion as pieces of a puzzle. The existing flooring technologies that are available are not suitable for use in milking parlours since the joints between adjacent mats allow fluids to leak there through, thereby creating potentially poor sanitary conditions.

There is a need for a rubber matting flooring system for equine and cattle which provide for a fluid proof surface and therefore good and enhanced sanitary conditions for cattle and equine and at the same time provides them with the soft flooring conditions that provide for healthy and thriving animals.

### SUMMARY OF THE INVENTION

The floor mat connection device claimed in claim 1 wherein the interlocking means including a male vertical portion connected to the male connector and a co-operating female vertical portion connected to the female connector, the vertical portions for operably interlocking the male and female connectors.

The floor mat connection device claimed in claim 2 wherein the male vertical portion including a male plug in leg and the female vertical portion including a female receptor such that urging the male plug in leg into the female receptor locks the male connector to the female connector.

The floor mat connection device claimed in claim 2 wherein the male vertical portion including a serrated leg, and the female vertical portion including a serrated receptor for receiving the serrated leg, such that urging the serrated leg into the serrated receptor interlocks the male and female connectors.

The floor mat connection device claimed in claim 4 wherein the serrations defined on the leg are adapted to interlock with the serrations defined in the serrated receptor.

The floor mat connection device claimed in claim 5 wherein the serrated receptor resiliently biassed to clamp the serrated leg.

The floor mat connection device claimed in claim 1 wherein said male connector including a male head and said female connector including a female head such that the mat ends being operably contoured to be sandwiched between the male head and female head.

The floor mat connection device claimed in claim 7 wherein the male head including a male horizontal portion and the female head including a female horizontal portion.

The floor mat connection device claimed in claim 8 wherein the male horizontal portion including perpendicular end flanges depending from each end, and the female horizontal portion including perpendicular end flanges depending from each end such that the end flanges adapted to be received in flange channels defined in the mat ends. The floor mat connection device claimed in claim 7 wherein said mat ends contoured such that said male head and female head being recessed into the mat ends such that the male cap and female cap being flush with the mat surface.

In combination a mat connector together with two mat ends, the combination comprising:
(a) a male connector wherein the male connector including a male head;
(b) a female connector and said female connector including a female head;
(c) a means for interlocking the male and the female connector such that the mat ends are sandwiched between portions of the male and female connector and the mat ends being operably contoured to be sandwiched between the male head and female head.

The combination claimed in claim 11 wherein the mat ends contoured such that said male head and female head being recessed into the mat ends such that the male cap and female cap being flush with the mat surface.

The combination claimed in claim 12 wherein the male head including a male horizontal portion and the female head including a female horizontal portion.

The combination claimed in claim 13 wherein the male horizontal portion including perpendicular end flanges depending from each end, and the female horizontal portion including perpendicular end flanges depending from each end such that the end flanges adapted to be received in flange channels defined in the mat ends.

The combination claimed in claim 11 wherein the mat ends including sealing channels extending adjacent and underneath the male head and the female head, wherein the sealing channel adapted to receive sealant therein for sealing the connectors to the mat ends thereby preventing liquid penetration through the connectors.

The combination claimed in claim 11 wherein the interlocking means including a male vertical portion connected to the male connector and a co-operating female vertical portion connected to the female connector, the vertical portions for operably interlocking the male and female connectors.

The combination claimed in claim 16 wherein the male vertical portion including a male plug in leg and the female vertical portion including a female receptor such that urging the male plug in leg into the female receptor locks the male connector to the female connector.

The combination claimed in claim 17 wherein the male vertical portion including a serrated leg, and the female vertical portion including a serrated receptor for receiving the serrated leg, such that urging the serrated leg into the serrated receptor interlocks the male and female connectors.

The combination claimed in claim 18 wherein the serrations defined on the leg are adapted to interlock with the serrations defined in the serrated receptor.

The combination claimed in claim 19 wherein the serrated receptor resiliently biassed to clamp the serrated leg.

A floor mat connection device for connecting mat ends together, said device comprising:
(a) a male connector;
(b) a female connector;
(c) a means for interconnecting said mail and said female connector, wherein said mat ends are sandwiched between portions of said male and female connector.

### BRIEF DESCRIPTION OF THE DRAWINGS

The invention will now be described by way of example only with reference to the following drawings:

FIG. 1 is a cross sectional schematic view of the mat connector in the assembled condition showing together with two floor mats.

FIG. 2 is a schematic perspective view the mat connector together with two floor mats.

FIG. 3 is a top perspective view of the male connector portion of the mat connection.

FIG. 4 is an inverted perspective view of the male connector portion of the mat connector.

FIG. 5 is a inverted perspective view of the female connector portion of the mat connector.

FIG. 6 is an upright perspective view of the female portion of the mat connector.

FIG. 7 is a top perspective view of the mat connector showing both the male connector and female connector portions in the interconnected position.

FIG. 8 is an alternate embodiment of the mat connector showing together with male and female portions and mats.

FIG. 9 which is a top perspective schematic view of the alternate embodiment of the mat connector showing together with the male portion and the female portion together with a mat.

FIG. 10 is a top perspective view of the female portion.

FIG. 11 is an inverted perspective view of the female portion.

FIG. 12 is an inverted perspective view of the male portion.

FIG. 13 is a top perspective view of the male portion.

FIG. 14 is a top perspective view of the male portion together with the female portion in the locked position.

### DETAILED DESCRIPTION OF THE PREFERRED EMBODIMENT

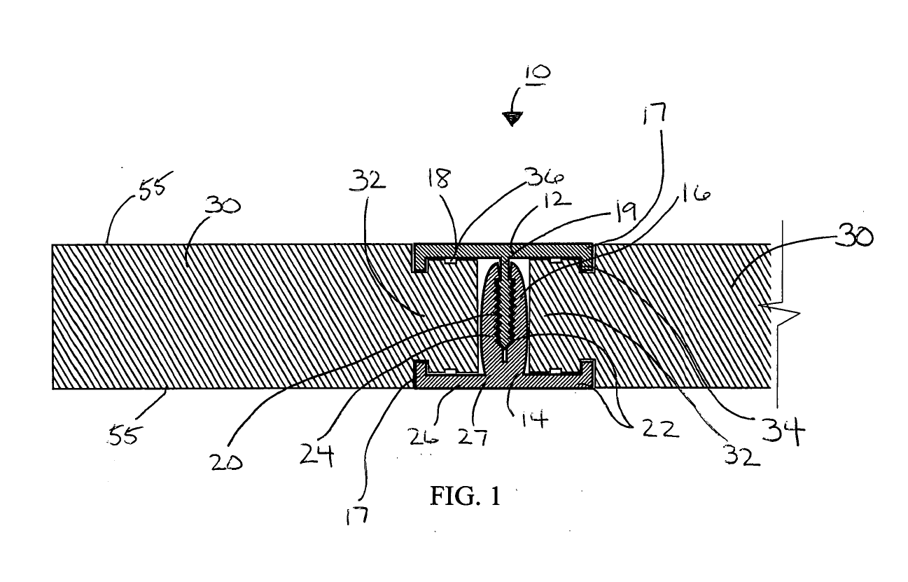

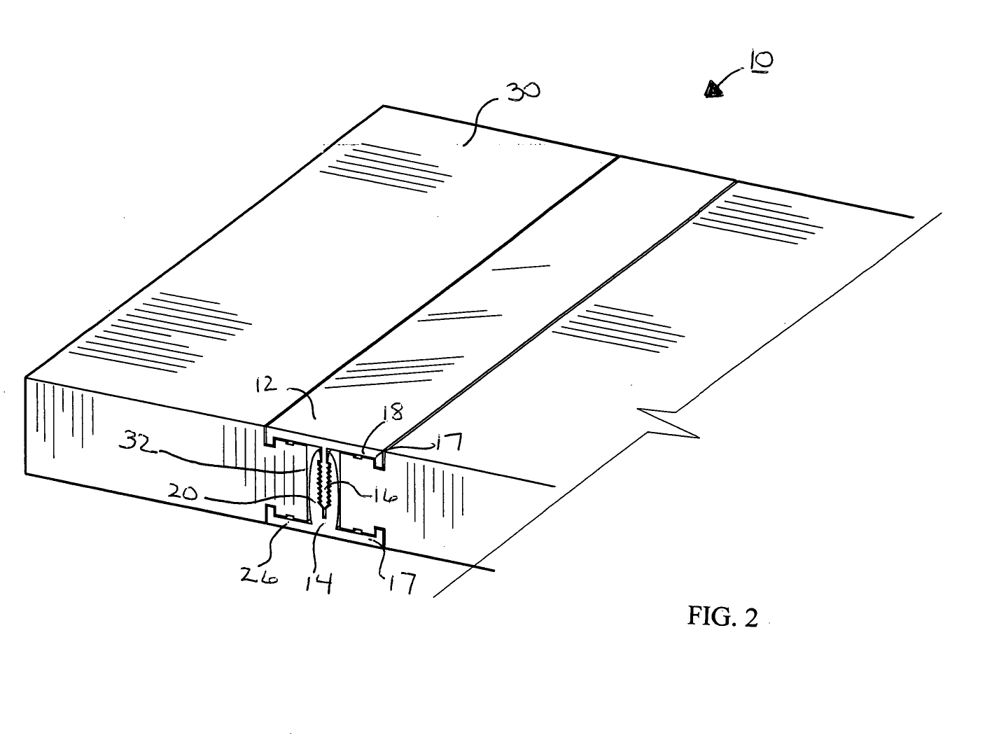

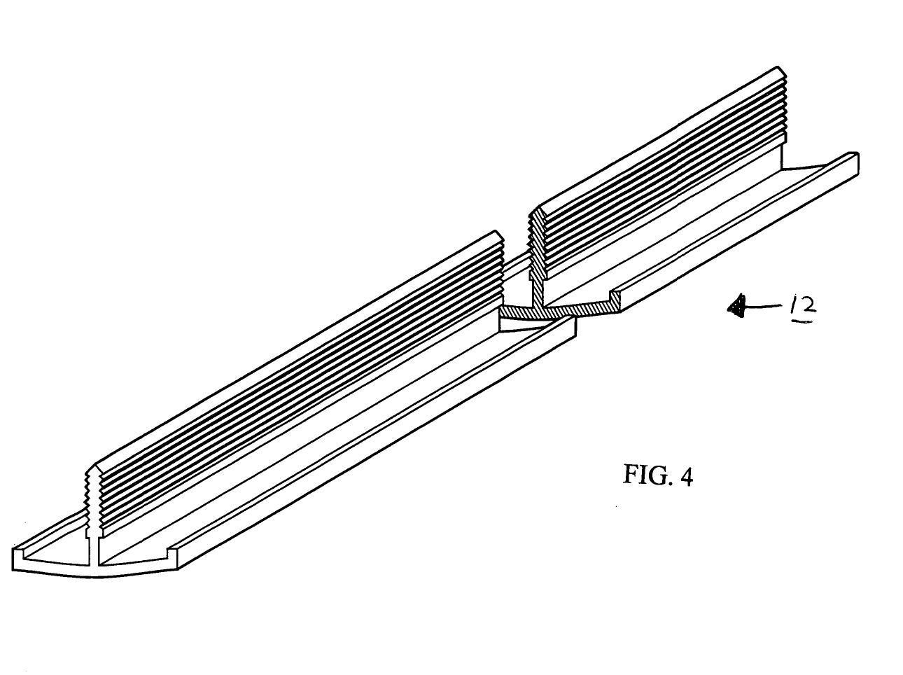

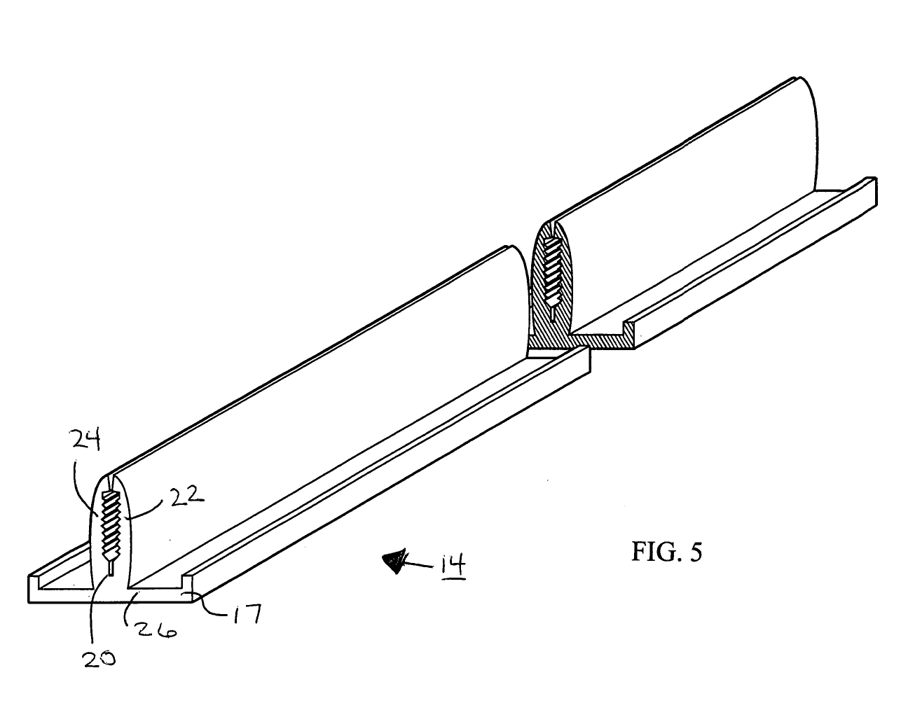

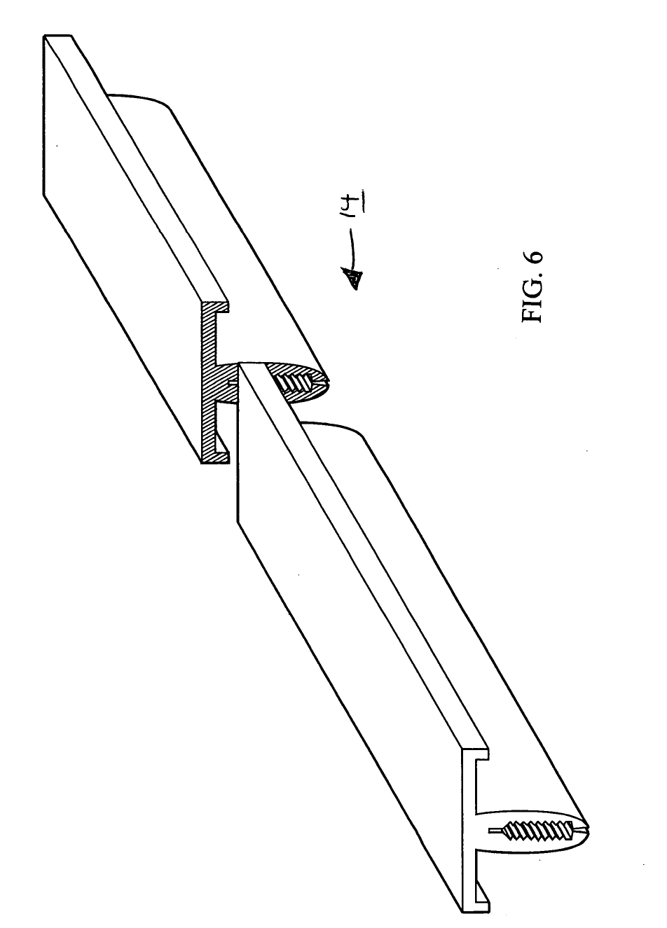

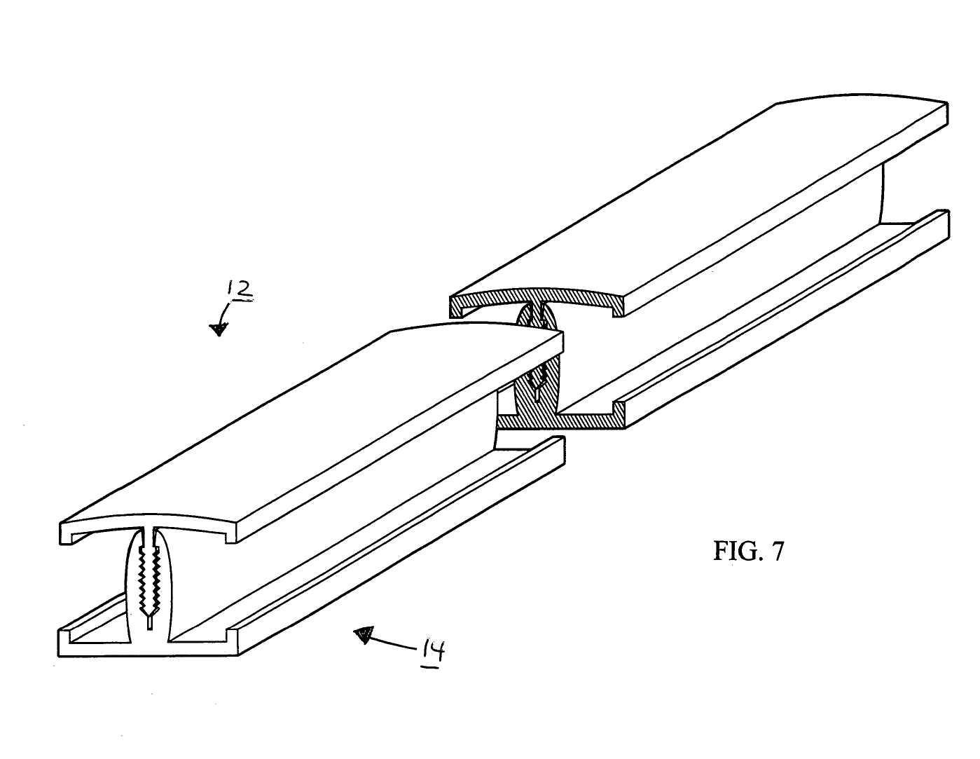

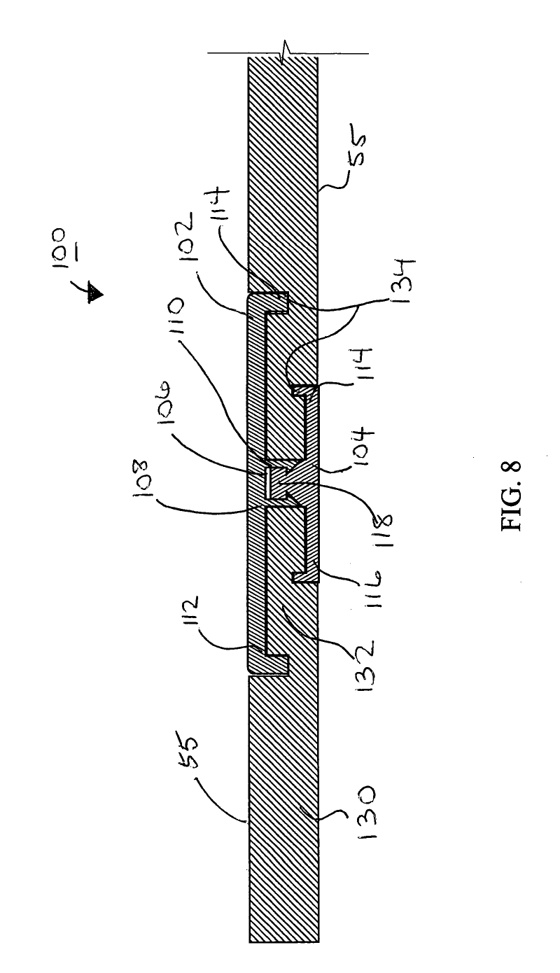

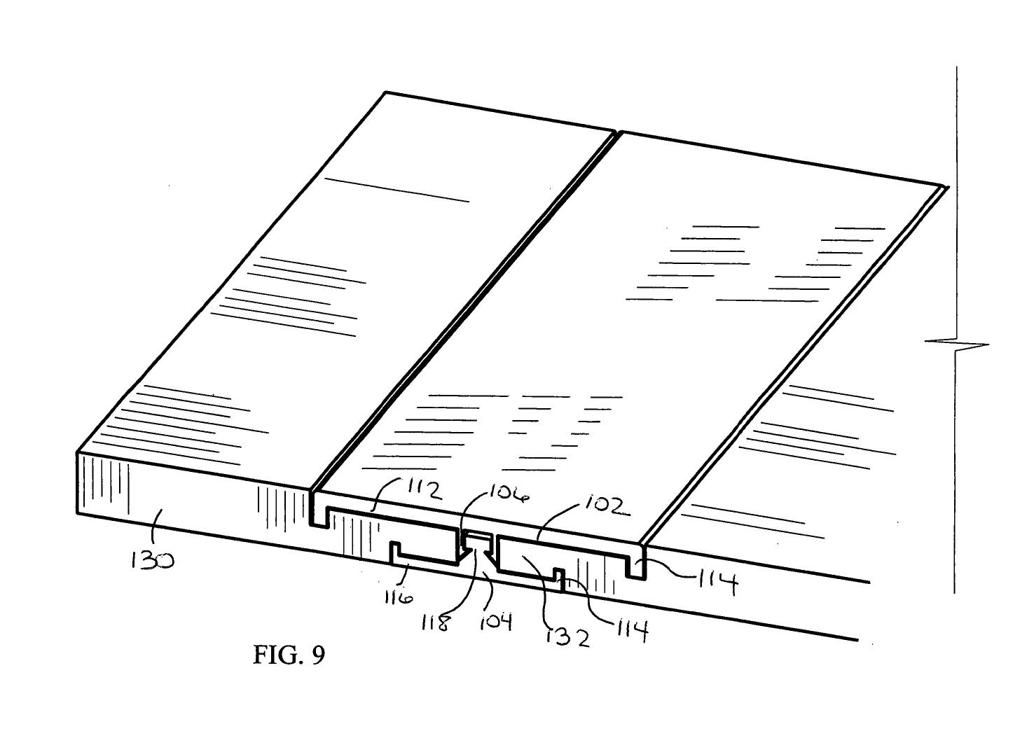

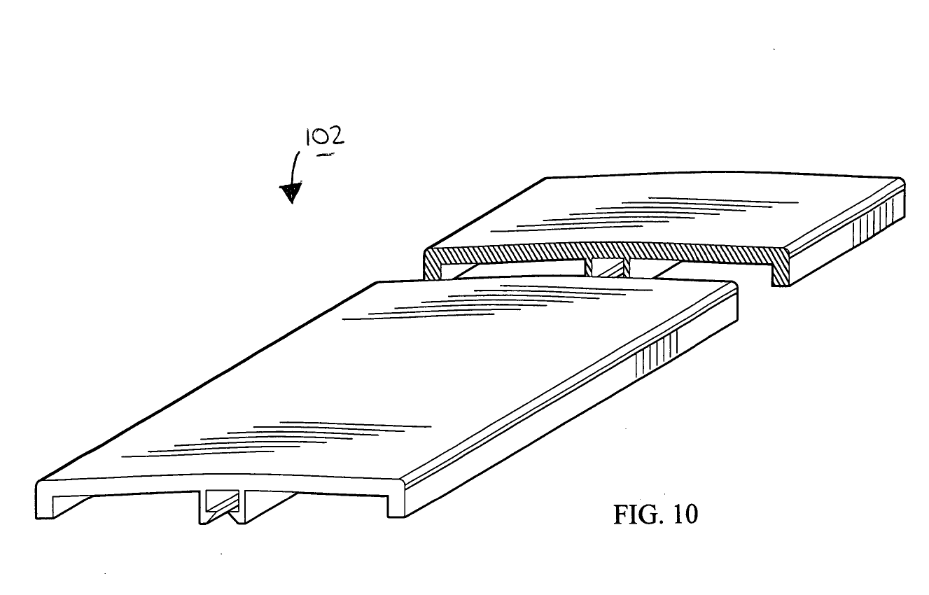

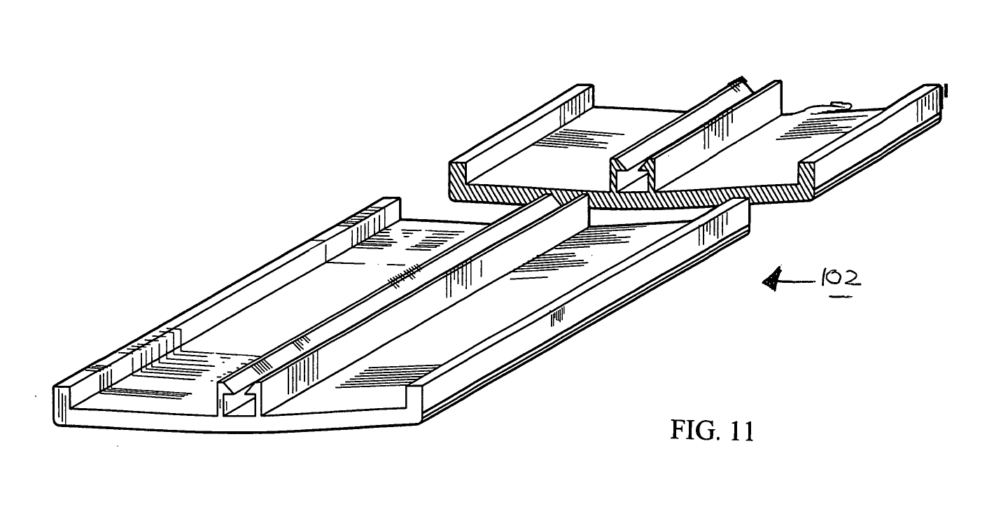

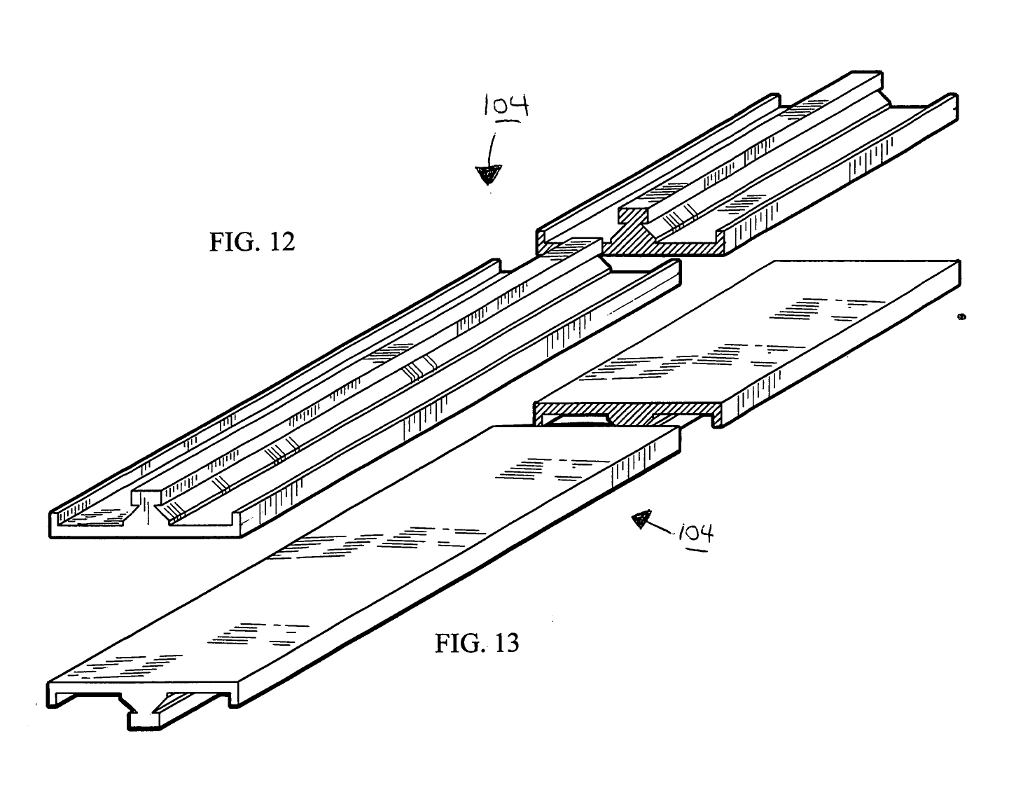

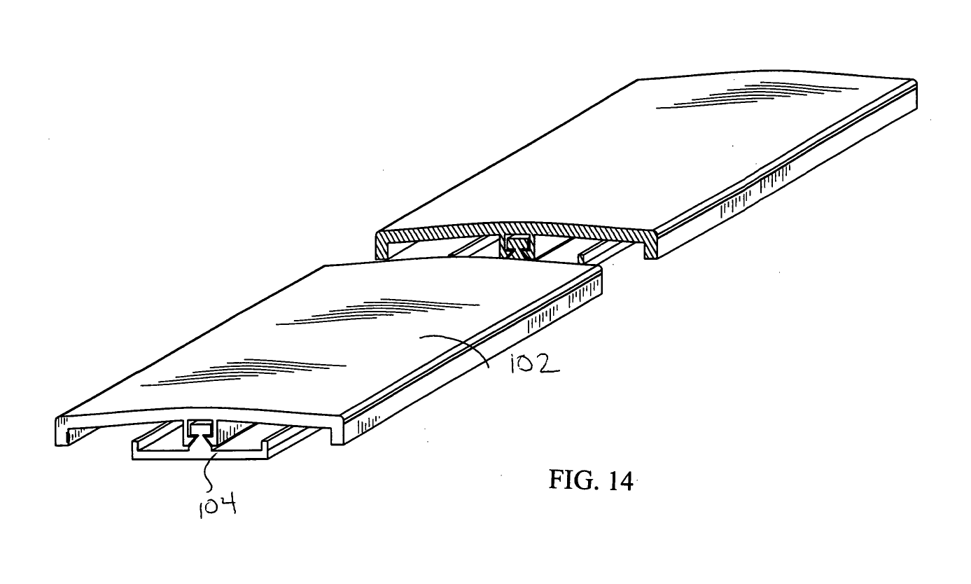

The present invention shown in FIGS. 1 to 14 is a mat connection system shown generally as mat connector 10 in FIG. 1 through 7 and mat connector 100 depicted in FIGS. 8 through 14.

Mat connector 10 which is the presently preferred embodiment, includes male connector 12 cooperatively interconnecting with a female connector 14. Male connector 12 includes a vertical serrated leg 16, male head 18, having a male horizontal portion 19 together with end flanges 17.

Female connector 14 includes serrated receptor 20 having a right receptor leg 22 and a left receptor leg 24, female head 26 having a female horizontal portion 27 and end flanges 17. The mat connector is suitable for connecting two floor mats 30 together, wherein floor mat 30 includes a mat end 32 and flange channels 34 as well as sealing channels 36.

An alternate embodiment of mat connector 10 is depicted as mat connector 100 in FIG. 8 through 14 and includes a female portion 102 and a male portion 104.

Female portion 102 includes a female receptor 106 having a left receptor portion 108 and a right receptor portion 110. Female receptor 106 also includes a female cap 112 having end portions 114.

Male portion 104 includes male cap 116, male plug in leg 118 and end portions 114.

Female portion 102 and male portion 104 are shown interconnected in FIG. 8 and are able to connect two mats together.

In Use

Mat connector 10 and mat connector 100 function in analogous fashion. The major differences between mat connector 10 and mat connector 100 is that mat connector 10 includes a series of serrations along serrated leg 16 which correspond and interlock with a number of serrations along serrated receptor 20 of mat connector 10. Whereas in mat connector 100, there is only a single male plug in leg 118 which cooperatively interconnects with a single female receptor 106 or put in other words there is only a single serration compared to mat connector 10.

Mat connector 10 permits one to connect two floor mats 30 together at a mat end 32. The mat ends 32 are adapted to cooperatively engage with the mat connector 10 as shown in FIG. 1. Mat end 32 is contoured in such a manner that male head 18 of male connector 12 and female head 26 of female connector 14 are flush with the top and bottom surfaces 55 of floor mat 30, when mat connector 10 is in the connected position as shown in FIG. 1.

To install mat connector 10, two mat ends 32 are placed with a slight distance between them in order to receive female connector 14 through the bottom and male connector 12 through the top. There is no reason why this connector could not work in inverted fashion, namely with male connector 12 at the bottom and female connector 14 at the top. By physically urging the serrated leg 16 into serrated receptor 20, the corresponding serrations in both the male connector 12 and female connector 14 interlock preventing separation of male connector 12 from female connector 14. The number of serrations or the depth of penetration of serrated leg 16 into serrated receptor 20 will depend on the thickness of floor mat 30 and therefore, this connector is suitable for use with varying thicknesses of floor mats 30. In addition, by forcibly plunging serrated leg 16 further down into serrated receptor 20, one can obtain a tighter fitting connection.

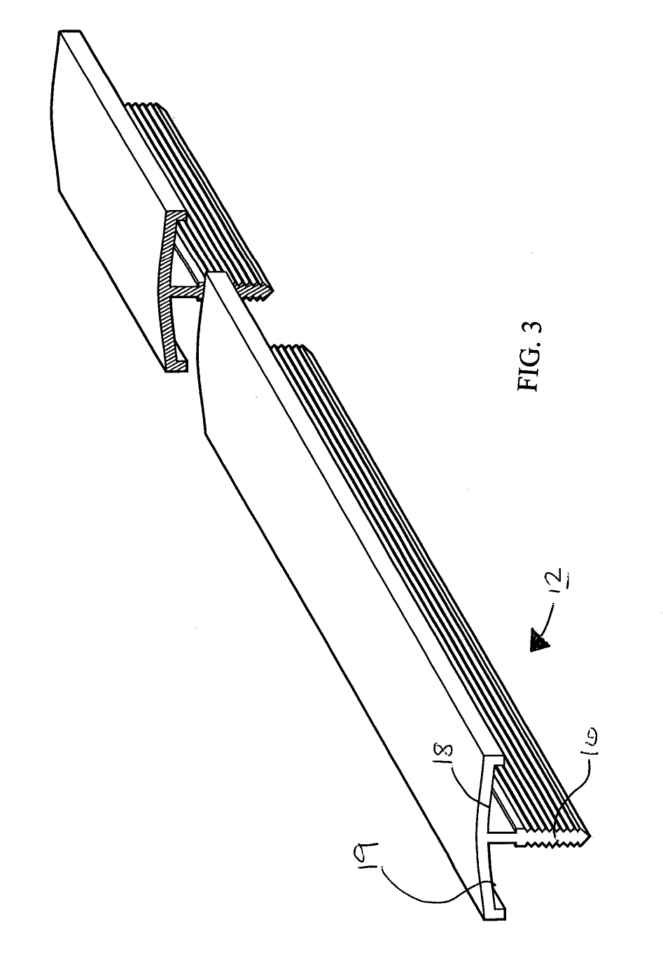

Referring to FIG. 3 for example, the male horizontal portion 19 has a slight curvature as depicted in FIG. 3. In the installed condition as shown in FIG. 1, the male horizontal portion 19 appears fairly horizontal, since the curvature of male horizontal portion 19 shown in FIG. 3 disappears once mat connector 10 is put into the installed or connected position as shown in FIG. 1. The curvature shown of male horizontal portion 19 is evident in male connector 12 only when in the uninstalled position as shown in FIG. 3.

Mat connector 10 is designed to provide for a liquid type seal between floor mats 30, preventing liquid from penetrating from the top of the mat through to the bottom of the connection. In order to aid and ensure the joint is leak proof, sealing channels 36 are added into mat end 32 which can accommodate a bead of sealant for example and/or a rubber gasket. In addition, the flange channels 34 defined in mat 30 which cooperatively accept end flanges 17 are designed to ensure that there is positive contact between the end of end flange 17 and flange channel 34.

In this manner, a person skilled in the art can see that mat connector 10 interconnects two floor mats 30 having modified mat ends to accommodate the male connector 12 and female connector 14 of mat connector 10. Further, one skilled in the art will note that because of the numerous serrations along serrated leg 16 and serrated receptor 20, mat connector 10 can accommodate floor mats 30 of varying thicknesses and still achieve a tight connection.

Mat connector 100 which is an alternate embodiment to mat connector 10, essentially functions in an analogous fashion, except that male portion 104 only contains a single serration, namely male plug in leg 18 which cooperatively fits together with female receptor 106, again only having a single cooperating serration. Since mat connector 100 only has a single serration as opposed to mat connector 10, it can only accommodate a single thickness of mats.

In addition, it will be apparent that female cap 112 appears to be wider than male cap 116 and it will be apparent to those skilled in the art that the size of female cap 112 and male cap 116 and for that matter the size or the width of male head 18 and female head 26 can be adjusted or uneven as shown in FIG. 8 or any other combination.

It should be apparent to persons skilled in the arts that various modifications and adaptation of this structure described above are possible without departure from the spirit of the invention the scope of which defined in the appended claim.

1. A floor mat connection device for connecting mat ends together, said device comprising:
(a) a male connector;
(b) a female connector;
(c) a means for interlocking the male and the female connector such that the mat ends are sandwiched between portions of the male and female connector.

2. The floor mat connection device claimed in claim 1 wherein the interlocking means including a male vertical portion connected to the male connector and a co-operating female vertical portion connected to the female connector, the vertical portions for operably interlocking the male and female connectors.

3. The floor mat connection device claimed in claim 2 wherein the male vertical portion including a male plug in leg and the female vertical portion including a female receptor such that urging the male plug in leg into the female receptor locks the male connector to the female connector.

4. The floor mat connection device claimed in claim 2 wherein the male vertical portion including a serrated leg, and the female vertical portion including a serrated receptor for receiving the serrated leg, such that urging the serrated leg into the serrated receptor interlocks the male and female connectors.

5. The floor mat connection device claimed in claim 4 wherein the serrations defined on the leg are adapted to interlock with the serrations defined in the serrated receptor.

6. The floor mat connection device claimed in claim 5 wherein the serrated receptor resiliently biassed to clamp the serrated leg.

7. The floor mat connection device claimed in claim 1 wherein said male connector including a male head and said female connector including a female head such that the mat ends being operably contoured to be sandwiched between the male head and female head.

8. The floor mat connection device claimed in claim 7 wherein the male head including a male horizontal portion and the female head including a female horizontal portion.

9. The floor mat connection device claimed in claim 8 wherein the male horizontal portion including perpendicular end flanges depending from each end, and the female horizontal portion including perpendicular end flanges depending from each end such that the end flanges adapted to be received in flange channels defined in the mat ends.

10. The floor mat connection device claimed in claim 7 wherein said mat ends contoured such that said male head and female head being recessed into the mat ends such that the male cap and female cap being flush with the mat surface.

11. In combination a mat connector together with two mat ends, the combination comprising:
(a) a male connector wherein the male connector including a male head;
(b) a female connector and said female connector including a female head;
(c) a means for interlocking the male and the female connector such that the mat ends are sandwiched between portions of the male and female connector and the mat ends being operably contoured to be sandwiched between the male head and female head.

12. The combination claimed in claim 11 wherein the mat ends contoured such that said male head and female head being recessed into the mat ends such that the male cap and female cap being flush with the mat surface.

13. The combination claimed in claim 12 wherein the male head including a male horizontal portion and the female head including a female horizontal portion.

14. The combination claimed in claim 13 wherein the male horizontal portion including perpendicular end flanges depending from each end, and the female horizontal portion including perpendicular end flanges depending from each end such that the end flanges adapted to be received in flange channels defined in the mat ends.

15. The combination claimed in claim 11 wherein the mat ends including sealing channels extending adjacent and underneath the male head and the female head, wherein the sealing channel adapted to receive sealant therein for sealing the connectors to the mat ends thereby preventing liquid penetration through the connectors.

16. The combination claimed in claim 11 wherein the interlocking means including a male vertical portion connected to the male connector and a co-operating female vertical portion connected to the female connector, the vertical portions for operably interlocking the male and female connectors.

17. The combination claimed in claim 16 wherein the male vertical portion including a male plug in leg and the female vertical portion including a female receptor such that urging the male plug in leg into the female receptor locks the male connector to the female connector.

18. The combination claimed in claim 17 wherein the male vertical portion including a serrated leg, and the female vertical portion including a serrated receptor for receiving the serrated leg, such that urging the serrated leg into the serrated receptor interlocks the male and female connectors.

19. The combination claimed in claim 18 wherein the serrations defined on the leg are adapted to interlock with the serrations defined in the serrated receptor.

20. The combination claimed in claim 19 wherein the serrated receptor resiliently biassed to clamp the serrated leg.
